(19) United States
(12) Patent Application Publication
(10) Pub. No.: US 2026/0370091 A1
(43) Pub. Date: Nov. 19, 2026

(54) MOTOR WITH INTEGRATED CONTROL WITH AIR CIRCULATION IN THE ELECTRONIC CONTROL UNIT

(71) Applicant: SAFRAN ELECTRICAL & POWER, PARIS (FR)

(72) Inventors: Abdoulahad THIAM, MOISSY CRAMAYEL (FR); Sachin AGGARWAL, MOISSY CRAMAYEL (FR); Christophe Elie Simon Marie CASTELLI, MOISSY CRAMAYEL (FR); Vincent Luc HIDELOT, MOISSY CRAMAYEL (FR)

(21) Appl. No.: 19/135,661

(22) PCT Filed: Dec. 5, 2023
(86) PCT No.: PCT/FR2023/051938

§ 371 Date: Jun. 4, 2025

(30) Foreign Application Priority Data
Dec. 8, 2022 (FR) FR2212998

(51) Int. Cl. H02K 9/06; B64D 27/34; H02K 5/20; H02K 11/33

(52) U.S. Cl. CPC H02K 9/06; B64D 27/34; H02K 5/207; H02K 11/33; H02K 2205/09; H02K 2211/03

(57) ABSTRACT

A motor with integrated control, includes an electric machine provided with at least one rotating part mounted on a drive shaft; an electronic control unit for controlling the electric machine; a casing including a first cavity in which the electric machine is housed and a second cavity in which the electronic control unit is housed, the drive shaft passing through both the first and second cavities, the second cavity being closed by at least one wall close to the first cavity; and an air-mixing device, housed in the second cavity and generating an air circulation within the second cavity so as to homogenise an air temperature within the second cavity.

### TECHNICAL FIELD OF THE INVENTION

This invention relates to a “Smart Motor” in which air circulation is integrated into the electronic control unit of the motor.

The invention finds applications in the fields of actuators, motor drives and electrical generation, especially as applied to aeronautics. In particular, it finds applications in the field of smart motors, for example for aircraft.

### TECHNOLOGICAL BACKGROUND OF THE INVENTION

In aeronautics, as in other fields, it is becoming increasingly common to use integrated control motors (called Smart Motors), which have the advantage of integrating both an electric machine and its electronic control unit in a same casing. The electric machine, for example a motor or generator, and the electronic control unit, for example an electronic power module, are arranged in two distinct cavities of a same casing.

FIG. 1 represents a front perspective view (drawing A), a rear perspective view (drawing C) and a transverse cross-section view (drawing B) of a smart motor 10. This smart motor 10 includes an electric machine 11 and an electronic control unit 12, both housed in a same casing 20. This casing 20 comprises two distinct cavities: a first cavity 21 in which the electric machine 11 is housed and a second cavity 22 in which the electronic control unit 12, also referred to as the control unit, is housed.

While such smart motors have advantages, such as compactness, they also have the drawback that the control unit 12, in its conventional form, does not cope well with high temperatures; indeed, at high temperatures, i.e. above about 125° C., the life time of the electronic components is dramatically reduced. However, during operation, the electric machine of a smart motor generates a lot of heat, which tends to raise the ambient temperature inside the first cavity 21 to over 160° C. As the first and second cavities communicate, the ambient air in the second cavity 22 reaches temperatures well above what the components of the control unit 12 can withstand. Thus, although electric machines are able to withstand temperatures that can reach 160° C., or even 180° C., the maximum temperature withstood by the control unit greatly limits applications of the smart motors.

A known solution for cooling the smart motor is to install cooling fins on the drive shaft rearwardly of the electric machine to create a stream of fresh air for cooling the motor casing. However, this solution does not prevent air in the first cavity from heating up the air inside the second cavity.

Another known solution for improving temperature resistance of the control unit is to relocate the control unit to a so-called fresh zone. This solution consists in relocating all the electronic components forming the control unit and connecting them to the electric machine via electrical harnesses. However, such a solution is not applicable to smart motors because, by the very fact of being relocated, the control unit is no longer arranged in the same casing as the electric machine and is therefore no longer “integrated”.

Another known solution for limiting the rise in temperature within the control unit is to oversize the electric machine so that it can operate at lower temperatures, for example in the order of 100 to 110° C., and not heat up the control unit. This solution, which is widely used in some fields such as industry and transport, causes an increase in the mass of smart motor, which is incompatible with aeronautical restrictions which require a reduction in the mass of aircraft elements and components.

Still another solution for improving temperature resistance of the control unit is to select so-called “high temperature” electronic components, which have the feature of being able to withstand high temperatures. However, this solution cannot be applied in aeronautics because this technology is new and in the process of being developed. It is therefore particularly expensive and most of the components are difficult or impossible to obtain. Moreover, when they do exist, these so-called high temperature compounds often have a low level of reliability.

Yet another solution contemplated to improve temperature resistance of the control unit is to create openings in the second cavity to renew air within said cavity. However, these openings lead to a problem of pollution, especially pollution by dust, at electronic components of the control unit, one of the effects of which is deteriorate said electronic components and therefore reduce their life time, which is contrary to the intended purpose.

A last known solution for improving temperature resistance of the control unit consists in integrating dedicated cooling into the smart motor. This cooling, for example in the form of a fluid circuit (air or liquid for example), is integrated inside the casing to cool not only components of the control unit but also the electric machine. This fluid cooling is generally associated with thermal insulation installed between the electric machine and the control unit, for example at the junction between the first cavity accommodating the electric machine and the second cavity accommodating the control unit. This thermal insulation generally takes the form of one or more thermal partitions 30, mounted between both cavities 21, 22 so that the control unit 12 cooled by the fluid flow does not heat up on contact with the ambient hot air of the first cavity.

With such thermal insulation, the second cavity 22 is substantially closed, shuttered, with no fluid exchange between the first and second cavities. In addition, the boards and other electronic components (FIG. 2) forming the control unit 12 are static elements, which do not rotate in the second cavity; air prevailing in this second cavity is therefore stagnant air, which does not circulate. Furthermore, for reasons of overall size, the electronic boards within the second cavity 22 are generally close to each other, which does not promote air circulation. However, it has been noticed that some zones inside the second cavity 22 are hotter than others. Indeed, some electronic boards generate more heat than others, resulting in hot spots. As shown in FIG. 2, which represents a temperature map of inside the second cavity, hot zones Zc are located in a same half of the second cavity, while cold zones Zf are located in the opposite half of the second cavity. Due to the stagnation of air within the second cavity, there is no heat exchange within said second cavity and components located in the hot zones Zc, or hot spots, have a further restricted life time than those located in the cold zones Zf of the second cavity.

There is therefore a real need for a technology for improving temperature resistance of the control unit components by preventing the creation of hot spots in the second cavity.

### SUMMARY OF THE INVENTION

In response to the problems discussed above of hot spots in the second cavity of the smart motor, the applicant provides a smart motor in which an air stirring device is installed in the second cavity in order to homogenise air temperature within said second cavity and thus improve thermal performance of the motor.

According to a first aspect, the invention relates to a smart motor comprising:
an electric machine provided with at least one rotating part mounted to a drive shaft,
an electronic control unit for controlling the electric machine,
a casing comprising a first cavity in which the electric machine is housed and a second cavity in which the electronic control unit is housed, the drive shaft passing through both the first and second cavities, the second cavity being closed by at least one wall in proximity to the first cavity,
   characterised in that it includes an air stirring device, housed in the second cavity and generating air circulation within the second cavity so as to homogenise air temperature within said second cavity.

By circulating an air flow within the second cavity, the ambient air in the second cavity is thermally homogenised in order to avoid hot spots. With thermally homogenous ambient air, components of the control unit have a more uniform life time, which extends the overall life time of the control unit.

Advantageously, the air stirring device is mounted integral about the drive shaft and rotatably driven by said drive shaft.

Mounting the air circulation device directly to the drive shaft ensures rotation of the device while avoiding addition of rotation equipment having inappropriate overall size for the space available within the second cavity.

Further to the characteristics just discussed in the preceding paragraph, the smart motor according to one aspect of the invention may have one or more additional characteristics from among the following, considered individually or according to any technically possible combination:
the air stirring device includes at least one agitating element mounted integral about the drive shaft, in a cleared zone of the second cavity.
the agitating element is a fin axially extending along the drive shaft.
the air stirring device includes several agitating elements distributed along the perimeter of the drive shaft.
the agitating element includes an overall rectangular shape with at least one projecting portion radially extending between electronic boards and components within the second cavity.
the agitating element is a vane radially extending from the drive shaft towards a circular wall of the second cavity.
the air stirring device includes several agitating elements, concentrically positioned with each other about the drive shaft.
the agitating elements are integral with each other and positioned between the wall of the second cavity and an electronic board.
the agitating element is a curved blade.
the casing includes draining ports located in a wall of the second cavity and cooperating with the air stirring device to thermally homogenise air within said second cavity.

According to a second aspect, the invention relates to an electric machine for aircraft, characterised in that it includes at least one smart motor according to the first aspect.

### BRIEF DESCRIPTION OF THE FIGURES

Further advantages and characteristics of the invention will become apparent upon reading the following description, illustrated by the figures in which:

FIG. 1, already described, represents a front perspective view (drawing A), a rear perspective view (drawing B) and a transverse cross-section view (drawing C) of a smart motor according to the state of the art;

FIG. 2, already described, represents a temperature map of inside the second cavity of the motor;

FIG. 3 represents a schematic transverse cross-section view of a smart motor according to the invention, in which several embodiments are represented;

FIG. 4 schematically represents a partial cross-sectional side view (drawing A), a partial perspective view (drawing B) and a complete perspective view (drawing C) of a smart motor according to a first embodiment of the invention, as well as a cross-section view of a fin of one embodiment of the stirring device integrated into the second cavity of the motor (drawing D);

FIG. 5 schematically represents a partial cross-sectional side view (drawing A), a partial perspective view (drawing B) and a complete perspective view (drawing C) of a smart motor according to a second embodiment of the invention;

FIG. 6A and FIG. 6B schematically represent the partial cross-sectional side views of the smart motor according to the first and second embodiments respectively, on which trajectories of the air flows generated by the air stirring device are indicated; and

FIG. 7 schematically represents a perspective view of a third embodiment of the stirring device of a smart motor according to the invention.

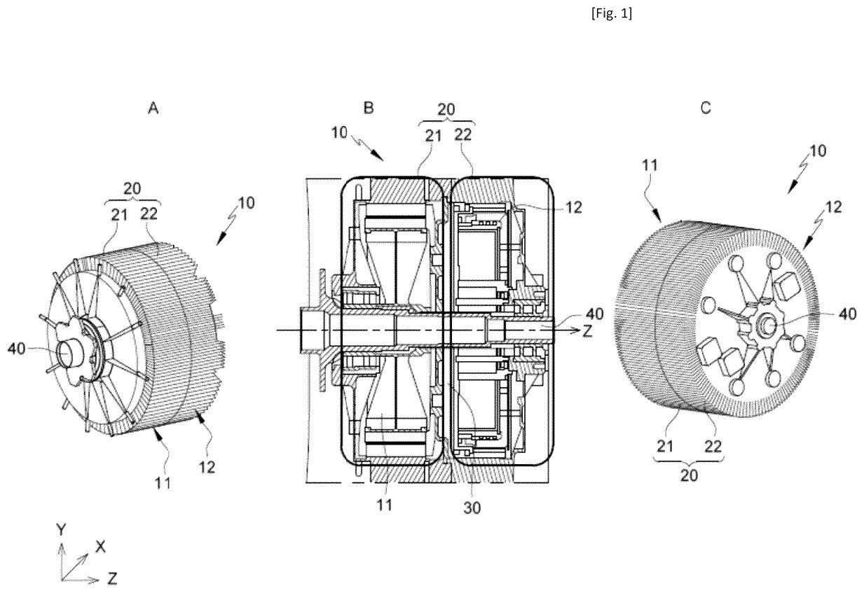

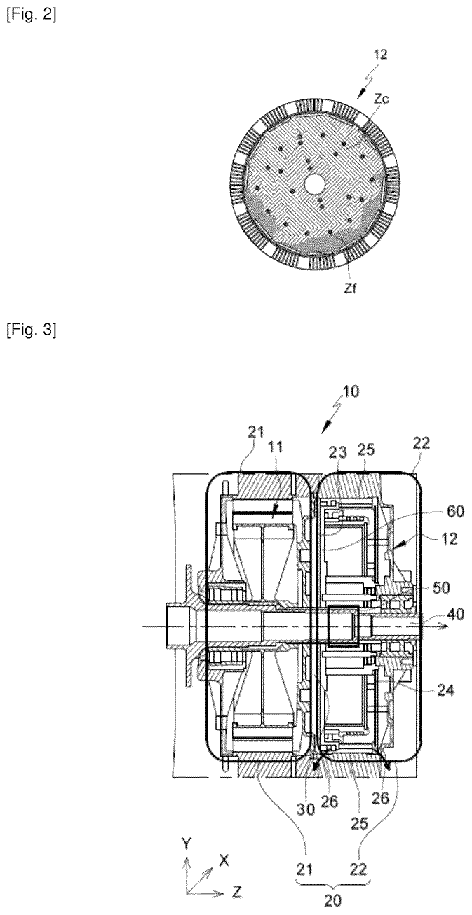

In the figures, identical elements are identified by identical references. For reasons of legibility, the size scales between elements represented are not respected.

### DETAILED DESCRIPTION

An exemplary embodiment of a smart motor, the second cavity of which is equipped with an air stirring device ensuring thermal homogenisation within the cavity, is described in detail hereinafter, with reference to the appended drawings. This example illustrates the characteristics and advantages of the invention. It is, however, reminded that the invention is not limited to this example.

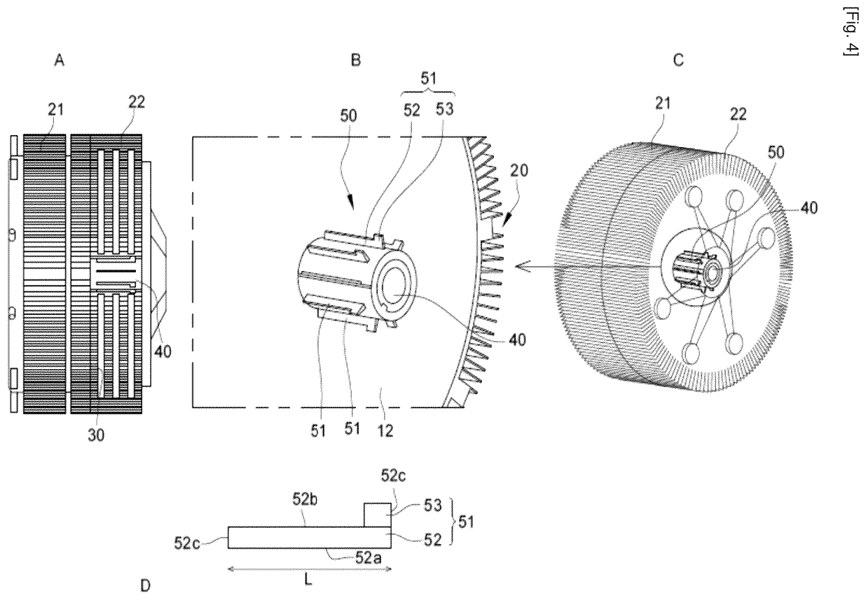

An example of a smart motor according to the invention is represented, in a cross-section view, in FIG. 3. This cross-section view of the smart motor of the invention is a transverse cross-section along the plane YZ of the reference frame XYZ, where Z is the longitudinal direction, Y is the radial direction and X is the transverse direction. The smart motor 10, more simply referred to as a motor, includes an electric machine 11 housed in the first cavity 21 of the casing 20 and a control unit 12 housed in the second cavity 22 of said casing 20. The first and second cavities are distinct from each other, separated by one or more thermal partitions 30.

The motor 10 further includes a drive shaft 40 which passes through the entire casing 20 and extends along the longitudinal axis Z. Indeed, in order to reduce forces on bearings of the drive shaft, it is selected to use, in the motor of the invention, a so-called “through” shaft which not only passes through the first cavity 21 but also the second cavity 22 of the casing 20. Indeed, although the electronic components of the control unit 12 are not integral with the drive shaft 40 (and are therefore not rotatably driven by said shaft), they are distributed about the drive shaft 40 which passes through the second cavity 22 at its centre. The invention suggests using the drive shaft 40 present in the second cavity 22 to rotatably drive an air stirring device 50 and/or 60. Rotation of this air stirring device 50 and/or 60 generates air circulation within the second cavity 22, in particular between the different components and electronic boards 120 of the control unit 12. This air circulation inside the second cavity 22 makes it possible to homogenise, or even out, temperature of air prevailing in said second cavity so as to avoid creation of hot spots. Indeed, stirring air in the second cavity makes it possible to blend or mix cold air from the cold zones Zf with hot air from the hot zones Zc so as to obtain thermal uniformity within the second cavity 22.

The air stirring device 50, 60, referred to more simply as the stirring device, is integrally mounted to the drive shaft 40. According to the embodiments, the air stirring device can be a part or a set of parts assembled and attached to the drive shaft 40, for example by welding or soldering or any other assembly method; alternatively, the stirring device 50, 60 can be made in one piece with the drive shaft or part of the drive shaft, for example by stamping, die-casting or additive manufacturing or any other manufacturing method.

The stirring device includes one or more agitating or mixing elements, integral with the drive shaft and installed in a cleared zone of the second cavity where the overall size is smaller, i.e. a zone free of electronic components or boards 120 or a zone where electronic components and boards 120 are relatively spaced apart. The agitating element(s) may, for example, be so-called “axial” agitating elements, installed at the centre of the second cavity 22 and mainly extending along the longitudinal axis Z, along the drive shaft 40; the stirring device including these axial agitating elements is a so-called “axial” device, referenced 50 in FIG. 3; this axial, essentially longitudinal, stirring device 50 is of low radial extension. On the other hand, the agitating element(s) may, for example, be so-called “radial” agitating elements, installed at one end of the second cavity 22 and mainly extending along the radial axis Y, from the drive shaft 40 towards the cylindrical wall of the casing 20; the stirring device including these radial agitating elements is a so-called “radial” device, referenced 60 in FIG. 3; this radial stirring device 60 is of low longitudinal extension.

According to one alternative, the second cavity 22 can accommodate two stirring devices, namely an axial stirring device 50 including one or more axial agitating elements and a radial stirring device 60 including one or more radial agitating elements.

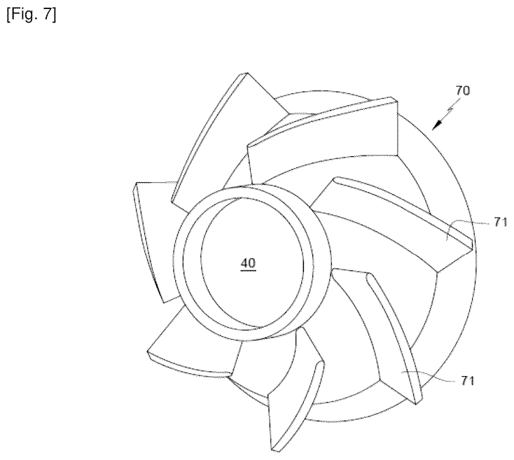

According to another alternative, the stirring device can extend mainly in an oblique direction, between the direction Y and the direction Z, as represented in the example of FIG. 7. The stirring device 70, still integral with the drive shaft 40, then includes agitating elements 71 extending in the oblique direction.

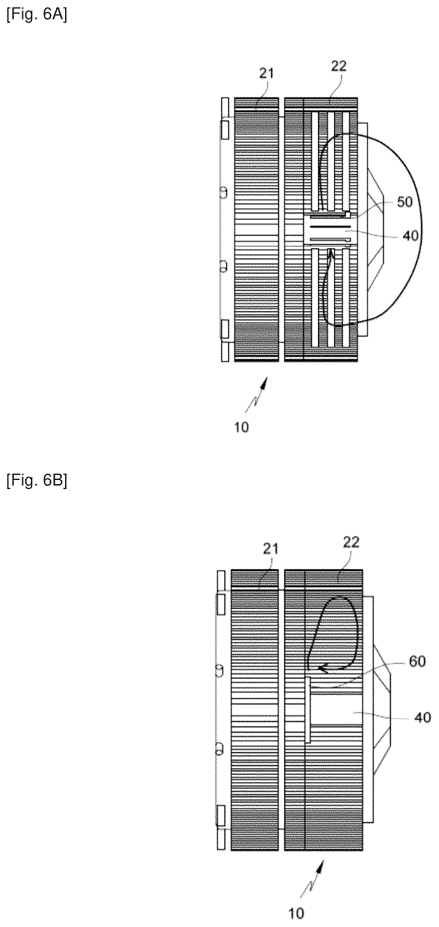

FIG. 4 represents an example of an axial stirring device 50 including a plurality of axial agitating elements 51 extending at the perimeter of the drive shaft 40 along the longitudinal axis Z. Drawing A in FIG. 4 shows a partial cross-section side view of a motor 10 equipped with the axial stirring device 50. Drawing B in FIG. 4 shows a partial perspective view of the stirring device 50 within the second cavity 22 of the motor 10. Drawing C in FIG. 4 shows a full perspective view of a motor 10 equipped with the stirring device 50. Drawing D in FIG. 4 shows an example of a cross-section of an agitating element 51 of the stirring device 50. In this embodiment, the agitating elements 51 are fins substantially evenly distributed about the perimeter of the drive shaft 40. The fins 51, driven by the drive shaft 40, rotate and stir air in the centre of the second cavity, thereby creating air circulation throughout the second cavity, as indicated by the arrow in FIG. 6A.

In this embodiment, the number of fins 51 is defined as a function of the applications and/or the motor model and the shape of the fins 51 is selected so as to embrace as closely as possible the shape of the electronic boards and components 120 to be cooled while ensuring the best ventilation performance. In the example of FIG. 4, the fins 51 have an overall rectangular shape with one or several radial protrusions for accelerating air between the electronic boards and components and thus further improving air circulation. More precisely, each fin 51 in the example of FIG. 4 includes:
a rectangular portion 52 having an integral side 52a, secured to the drive shaft 40, a free side 52b, opposite to the integral side 52a, and two outer sides 52c each connecting a free side and an integral side. The integral 52a and the free 52b sides are preferably larger than the outer sides; and
a projecting portion 53 which extends from the free side 52b of the rectangular portion 52, in the radial direction Y.

In the example of FIG. 4, the projecting portion 53 extends from one end of the rectangular portion 52-(for example in continuity with an outer side 52c). Alternatively, the projecting portion 53 may extend from the centre of the rectangular portion or from anywhere on the free side 52b of the rectangular portion, depending on the space available. In one alternative, several projecting portions 53 extend from the free side 52b of the rectangular portion 52.

The shape and dimensions of the rectangular portion 52 and the projecting portion 53 of the fins 51 are defined as a function of the overall size within the second cavity 22, i.e. depending on the space available between the electronic boards and components of the control unit 12 in the vicinity of the drive shaft 40. The more the environment about the drive shaft is clear of any electronic boards and/or components, the larger the rectangular portion 52 and/or the projecting portion 53 of the fins 51 can be.

Of course, the shape of the fins may be different from that represented in FIG. 4. Other shapes of fins 61 may be contemplated depending on the applications and/or space available. The fins 51 may, for example, have a semi-ovoid cross-section (i.e. with a curved free side) or a sinusoidal shape (i.e. with the free and integral sides forming a kind of S), or any other contemplatable profile shape for ventilation vanes.

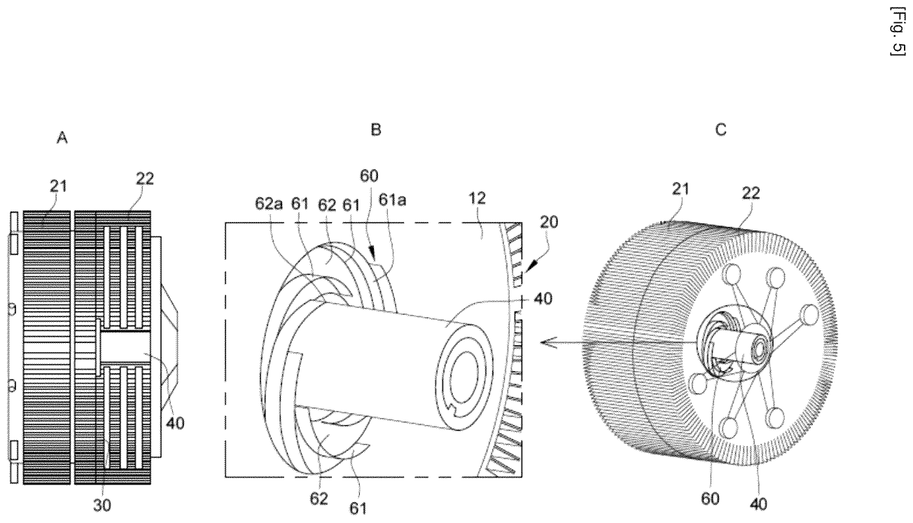

FIG. 5 represents an example of a radial stirring device 60 including a plurality of agitating elements 61 extending concentrically about the drive shaft 40 along the longitudinal axis Y. Drawing A in FIG. 5 shows a partial cross-section side view of a motor 10 equipped with the radial stirring device 60. Drawing B in FIG. 5 shows a partial perspective view of the radial stirring device 60 within the second cavity 22 of the motor 10. Drawing C in FIG. 5 shows a complete perspective view of a motor 10 equipped with the radial stirring device 60. In this embodiment, the agitating elements 61 are vanes which extend radially and concentrically about the drive shaft 40 and which are positioned along the wall of the second cavity close to the thermal partition 30. In this way, the vanes 61, driven by the drive shaft 40, rotate and circulate air from the cold side of the motor towards the hottest part of the second cavity, i.e. the part closest to the motor. This direction of air circulation, represented by the arrow in FIG. 6B, not only makes it possible to thermally homogenise the air, but also to obtain a forced convective exchange with the outer wall 24 of the second cavity, which is the coldest wall of said cavity.

In this embodiment, each vane 61 is a curved blade at least partially surrounding the drive shaft 40. The radial stirring device 60 may include a single vane 61, for example of helical shape, secured to the drive shaft. Preferably, it can include several vanes 61 secured both to each other and to the drive shaft. The number of vanes 61 on the stirring device 60 and the shape of the vanes may vary depending on the application, the space available and/or the motor model.

In one embodiment, the vanes 61 can be attached to each other, for example by their ends, with one of the vanes 61 also being attached to the drive shaft.

In another embodiment, represented in FIG. 5, the radial stirring device 60 includes several vanes 61, each in the shape of an arc of a circle, staggeredly disposed relative to each other so as to surround the drive shaft 40. The vanes 61 are each attached to a support 62, which in turn is secured to the drive shaft 40. In the example of FIG. 5, the support 62 is a disc, positioned in the plane XY and secured to the drive shaft by its inner contour 62a (i.e. the internal diameter of the disc). The vanes 61 are attached to the support disc 62, for example by welding, soldering or adhering (or any other attachment method previously described in paragraph [0033]), via one of their lateral faces 61a. The support disc 62 and vanes 61 assembly is positioned along the inner wall 23 of the second cavity 22, the inner wall 23 being the wall closest to the first cavity 21, i.e. that located in proximity to the thermal partition 30.

Depending on the applications and/or the motor, the vanes 61 may have different shapes and dimensions. They may, for example, surround the drive shaft at an angle of about 30°, 90° or 180° or any other angle. The thickness of the vanes 61 can also vary from one vane to another or along the length of the vane. The curvature of the vane 61 and its length can also vary. The dimensions of the vanes 61 and of the support disc 62 can be adapted as a function of the overall size of the second cavity 22, i.e. depending on the space available between the inner wall 23 of the second cavity 22 and the electronic boards inside said second cavity. The clearer the environment along the inner wall 23, the greater the width of the vanes 61 (i.e. the dimension of the vanes in the longitudinal direction) and/or the diameter of the support disc 62.

In some embodiments, the electronic boards inside the second cavity can be disposed in such a way as to further promote air circulation from the outer wall 24 to the inner wall 23.

Depending on the model, the motors 10 may include draining ports, located especially in the wall of the second cavity 22, the purpose of which is to allow condensates to drain away. One embodiment of the invention, represented in FIG. 3, uses these draining ports in conjunction with the stirring device 50, 60 to stir the air within the second cavity. These draining ports, referred to as 26 in FIG. 3, are located in the circular wall 25 of the second cavity, for example at the junction between the circular wall 25 and each of the inner 23 and the outer 24 walls. These draining ports 26 work with the stirring device to force air circulation inside the second cavity 22, between the electronic boards and components 120.

Although described in a number of examples, alternatives and embodiments, the smart motor according to the invention comprises various alternatives, modifications and improvements which will be obvious to the person skilled in the art, it being understood that these alternatives, modifications and improvements are within the scope of the invention.

1. A smart motor comprising:
an electric machine provided with at least one rotating part mounted to a drive shaft,
an electronic control unit for controlling the electric machine,
a casing comprising a first cavity in which the electric machine is housed and a second cavity in which the electronic control unit is housed, the drive shaft passing through both the first and second cavities, the second cavity being closed by at least one wall in proximity to the first cavity, and
an air stirring device, housed in the second cavity and generating air circulation within the second cavity so as to homogenise air temperature within said second cavity, wherein the air stirring device includes several agitating elements mounted integral about the drive shaft, in a cleared zone of the second cavity and concentrically positioned with each other about the drive shaft, and wherein the agitating element is a vane radially extending from the drive shaft towards a circular wall of the second cavity.

2. The smart motor according to claim 1, wherein the air stirring device is mounted integral about the drive shaft and rotatably driven by said drive shaft.

3. The smart motor according to claim 2, wherein the agitating element is a fin axially extending along the drive shaft.

4. The smart motor according to claim 3, wherein the air stirring device includes a plurality of agitating elements distributed along the perimeter of the drive shaft.

5. The smart motor according to claim 3, wherein the agitating element (51) includes an overall rectangular shape with at least one projecting portion radially extending between electronic boards and components within the second cavity.

6. The smart motor according to claim 1, wherein the agitating elements are integral with each other and positioned between the wall of the second cavity and an electronic board.

7. The smart motor according to claim 1, wherein the agitating element is a curved blade.

8. The smart motor according to claim 1, wherein the casing includes draining ports located in a wall of the second cavity and cooperating with the air stirring device to thermally homogenise air within said second cavity.

9. An electric machine for an aircraft, comprising at least one smart motor according to claim 1.
